(19) United States
(12) Patent Application Publication
(10) Pub. No.: US 2023/0051339 A1
(43) Pub. Date: Feb. 16, 2023

(54) SHEAR STUD WELDING SYSTEM

(71) Applicant: WALTERS INC., Hamilton (CA)

(72) Inventors: Ryan Koppelaar, Ancaster (CA); Kyle Sieber, Beamsville (CA); Valerii Federov, Hamilton (CA)

(21) Appl. No.: 17/401,205

(22) Filed: Aug. 12, 2021

(51) Int. Cl. B23K 9/20; B23K 9/32; B23K 37/02; B25J 11/00; B25J 15/06; B25J 13/08

(52) U.S. Cl. CPC B23K 9/206; B23K 9/327; B23K 9/208; B23K 37/0252; B25J 11/005; B25J 15/0616; B25J 13/081

(57) ABSTRACT

A shear stud welding system is disclosed. The system comprises a shear stud holder, a robotic arm and a microcontroller. The shear stud holder comprises a turret and a first motor coupled to the turret and configured to rotate the turret about an axis to a predetermined angle such that a shear stud among the plurality of shear studs is at a dispensing position. The robotic arm is configured to transfer the shear stud from the shear stud holder to a workpiece. The microcontroller is configured to control the movement of the robotic arm to pick up the shear stud from the dispensing position and transfer the shear stud holder to the workpiece at a welding position and cause the first motor to rotate the turret to a predetermined angle to cause a shear stud among the plurality of shear studs assume the dispensing position.

### BACKGROUND

### Field of Invention

The disclosed subject matter relates to the field of welding systems. More particularly, but not exclusively, the subject matter relates to robotic shear stud welding system. The disclosure applies equally to robotic and cobotic systems.

### Discussion of Prior Art

Shear stud welding process is typically used to weld shear studs to a workpiece. An electrical arc is generated between the stud and the workpiece which causes the portion of the stud and the workpiece that is in proximity to the arc to melt. Further, pressure is applied to the stud to plunge the stud into the workpiece thereby forming a welded joint. There are two different types of shear stud welding, namely, stud arc welding and capacitor discharge stud welding.

A welding gun is used to weld the stud with the workpiece. A human operator manually loads the welding gun with the shear stud and a ferrule. Further, the human operator positions the welding gun against the workpiece. The shear stud that is in the welding gun and the workpiece are at opposite electrical polarity. This causes a formation of arc between the stud and the workpiece. Further, the human operator may activate a plunging mechanism to plunge the stud into the workpiece thereby joining the stud and the workpiece. This is a cumbersome process since the human operator must manually load the stud into the welding gun and further manually position the welding gun at the welding position. Therefore, the use of a human operator to perform shear stud welding is time consuming and inefficient.

In case of an automated shear stud welding system, the automated welding system can automatically position the welding gun at the welding site. However, even in this case, the shear stud has to be manually loaded into the welding gun by a human operator. Therefore, even the automated shear stud welding system proves to be rather inefficient.

In view of the foregoing, it is evident that there is a need for an improved system for shear stud welding.

### SUMMARY

In an embodiment a shear stud welding system is disclosed. The system comprises a shear stud holder, a robotic arm and a microcontroller. The shear stud holder comprises a turret configured to hold a plurality of shear studs and a plurality of ferrules and a first motor coupled to the turret, wherein the first motor is configured to rotate the turret about an axis to a predetermined angle such that a shear stud among the plurality of shear studs is at a dispensing position. The robotic arm is configured to transfer the shear stud from the shear stud holder to a workpiece. The robotic arm comprises a welding gun comprising a gripper configured to hold the shear stud along with the ferrule, wherein the robotic arm causes the gripper to pick up a shear stud from the shear stud holder from the dispensing position. The microcontroller is connected to the shear stud holder and the robotic arm. The microcontroller is configured to control the movement of the robotic arm to pick up the shear stud from the dispensing position and transfer the shear stud holder to the workpiece at a welding position, control the welding of the shear stud with the workpiece and cause the first motor to rotate the turret to a predetermined angle upon welding of a shear stud to the workpiece, wherein the rotation of the turret causes a shear stud among the plurality of shear studs assume the dispensing position.

### BRIEF DESCRIPTION OF DRAWINGS

Embodiments are illustrated by way of example and not limitation in the figures of the accompanying drawings, in which like references indicate similar elements and in which:

FIG. 1 illustrates a block diagram of a shear stud welding system 100, in accordance with an embodiment;

FIG. 2 illustrates the shear stud welding system 100, in accordance with an embodiment;

FIG. 3A and 3B illustrates a shear stud holder 102, in accordance with an embodiment;

FIG. 4 illustrates a robotic arm 104, in accordance with an embodiment; and

FIG. 5 is a flowchart of a shear stud welding process, in accordance with an embodiment.

### DETAILED DESCRIPTION

The following detailed description includes references to the accompanying drawings, which form a part of the detailed description. The drawings show illustrations in accordance with example embodiments. These example embodiments, which may be herein also referred to as “examples” are described in enough detail to enable those skilled in the art to practice the present subject matter. However, it may be apparent to one with ordinary skill in the art, that the present invention may be practised without these specific details. In other instances, well-known methods, procedures and components have not been described in detail so as not to unnecessarily obscure aspects of the embodiments. The embodiments can be combined, other embodiments can be utilized, or structural, logical, and design changes can be made without departing from the scope of the claims. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

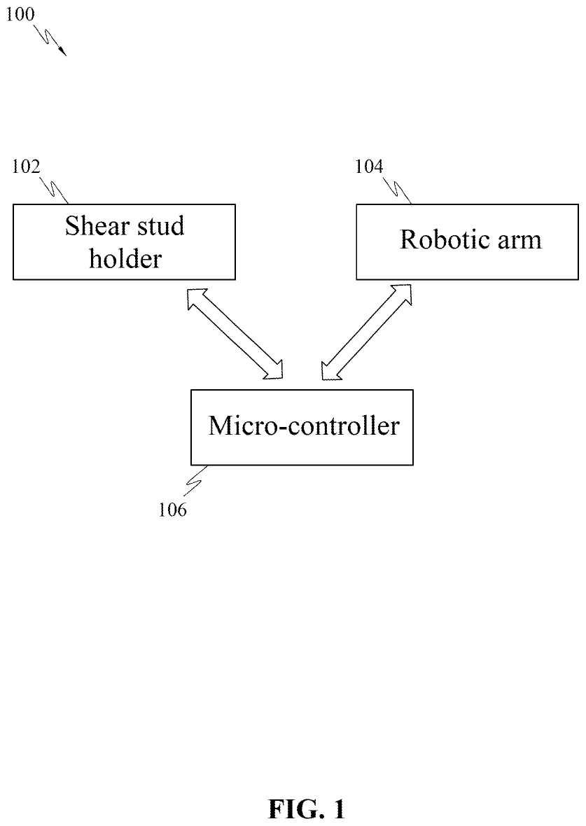

FIG. 1 illustrates a shear stud welding system 100, in accordance with an embodiment. The system 100 may comprise a shear stud holder 102, a robotic arm 104 and a microcontroller 106. The microcontroller 106 may be configured to control the operation of the shear stud holder 102 and the robotic arm 104.

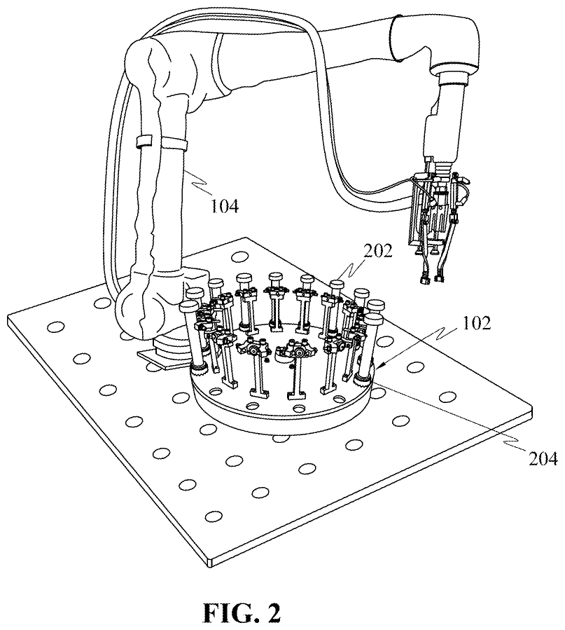

Referring to FIG. 2, the shear stud holder 102 may be configured to hold a plurality of shear studs 202 and a plurality of ferrules 204. Further, the robotic arm 104 may be configured to transfer each of the shear stud 202 from the shear stud holder 102 to a workpiece. Further, the microcontroller 106 may be connected to the shear stud holder 102 and the robotic arm 104 to coordinate the functioning of the shear stud holder 102 and the robotic arm 104.

In an embodiment, the shear stud welding system 100 may be a stud arc welding system or a capacitor discharge stud welding system.

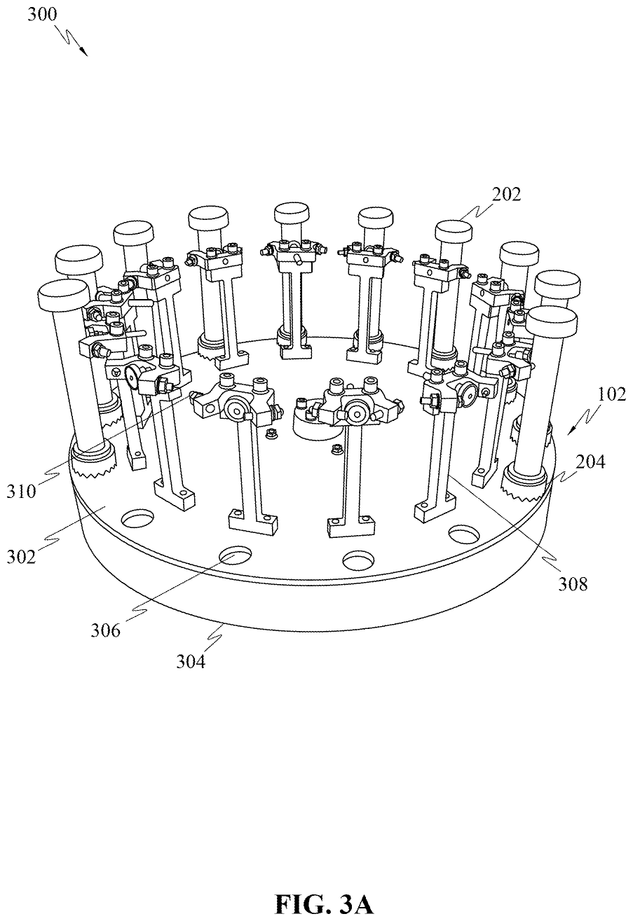

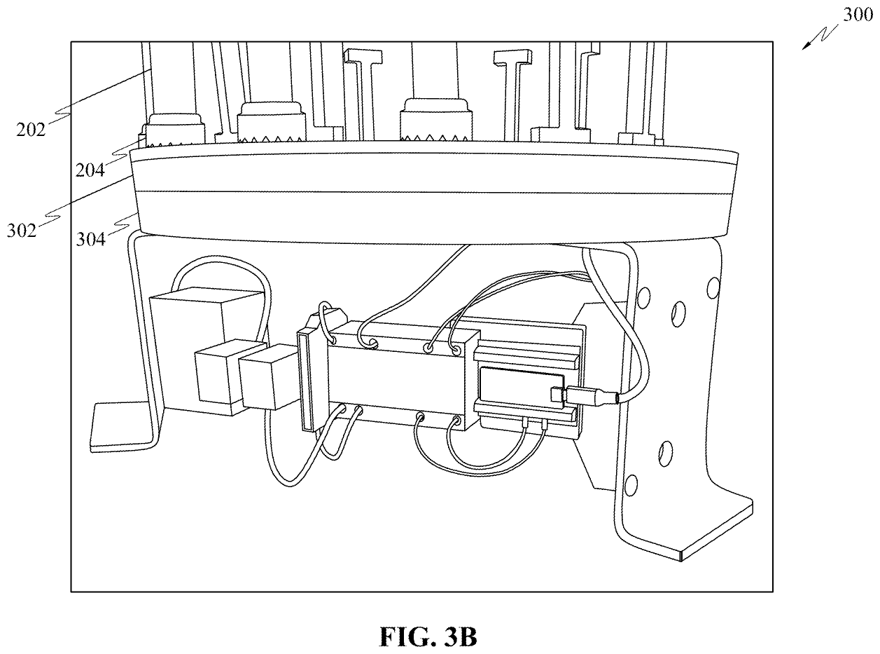

FIG. 3A and 3B illustrates the shear stud holder 102, in accordance with an embodiment. The shear stud holder 102 may comprise a turret 302, a stationary block 304 and a first motor (not shown) coupled to the turret 302. The turret 302 may be configured to hold the plurality of shear studs 202 and the plurality of ferrules 204. Each of the ferrule 204 may be engaged with one shear stud 202. Further, the shear studs 202 along with the ferrules 204 may be arranged in a circular arrangement. The turret 304 may be coupled to the first motor, wherein the first motor may be configured to rotate the turret 302 about an axis to a predetermined angle, such that a shear stud 202 among the plurality of shear studs is at a dispensing position. The robotic arm 104 may be configured to pick up the shear stud 202 from the dispensing position.

In one embodiment, the turret 302 may be coupled to a stationary block 304 via a bearing (not shown), wherein the stationary block 304 may further be rigidly coupled to a base.

In one embodiment, the turret 302 may define a plurality of cavities 306 wherein each of the plurality of cavities 306 may be configured to receive at least a portion of a shear stud 202.

In one embodiment, the turret 302 may comprise a plurality of support structures 308. Each of the support structures 308 may be configured to support a shear stud 202 in a vertical position.

In one alternative, other automated feeder systems may be used in place of the turret, such as a linear feeder. Using a linear feeder may permit more studs to be loaded at one time.

In one embodiment, each of the support structures 308 may further comprise a pair of fasteners 310 to tightly secure the shear stud 202 to the support structure 308.

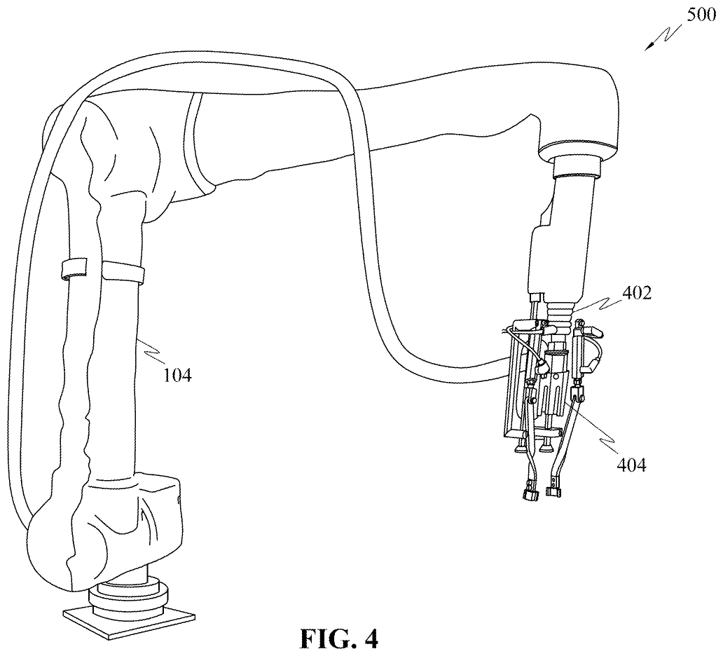

FIG. 4 illustrates a robotic arm 104, in accordance with an embodiment. The robotic arm 104 may comprise a welding gun 402 comprising a gripper 404 configured to hold the shear stud 202 along with the ferrule 204. The gripper 404 may pick up a shear stud 202 from the shear stud holder 102 at a dispensing position and move the shear stud 202 to a welding position on the workpiece.

In one embodiment, the gripper 404 may constrict at the dispensing position to hold the shear stud 202 and the ferrule 204 securely and further open at the welding position after welding the shear stud 202 to the workpiece to release the shear stud 202.

In one embodiment, the gripper 404 may be an air actuated gripper. Further, the system 100 may comprise a pneumatic mechanism to control the constriction and opening of the air actuated gripper. The microcontroller 106 may be configured to operate the pneumatic mechanism, thereby automatically controlling the constriction and opening of the air actuated gripper 404.

In one embodiment, the welding gun 402 may comprise a plunging mechanism that may be coupled to the gripper 404. The plunging mechanism may enable the gripper 404 along with the shear stud 202 and the ferrule 204 to traverse towards and away from the workpiece.

In one embodiment, the welding gun 402 may comprise a welding cable electrically connected to the shear stud 202 via the gripper 404 to maintain an electrical polarity at the shear stud 202. Further, the workpiece may be at an electrical polarity that is opposite to the electrical polarity of the shear stud 202. Therefore, when the welding gun 402 with the shear stud 202 is held up against the workpiece, the plunging mechanism of the welding gun 402 may adjust the gap between the workpiece and the shear stud 202. The gap causes an arc to be generated between the workpiece and the shear stud 202. The arc melts the portion of the workpiece and the shear stud 202 around the arc and further the plunging mechanism may push the shear stud 202 against the workpiece to form a welded joint. The ferrule 204 around the shear stud 202 may be configured to shield the arc during welding. The ferrule 204 may later be chipped off after welding the shear stud 202 with the workpiece.

In one embodiment, the ferrule 204 may be made using a ceramic material.

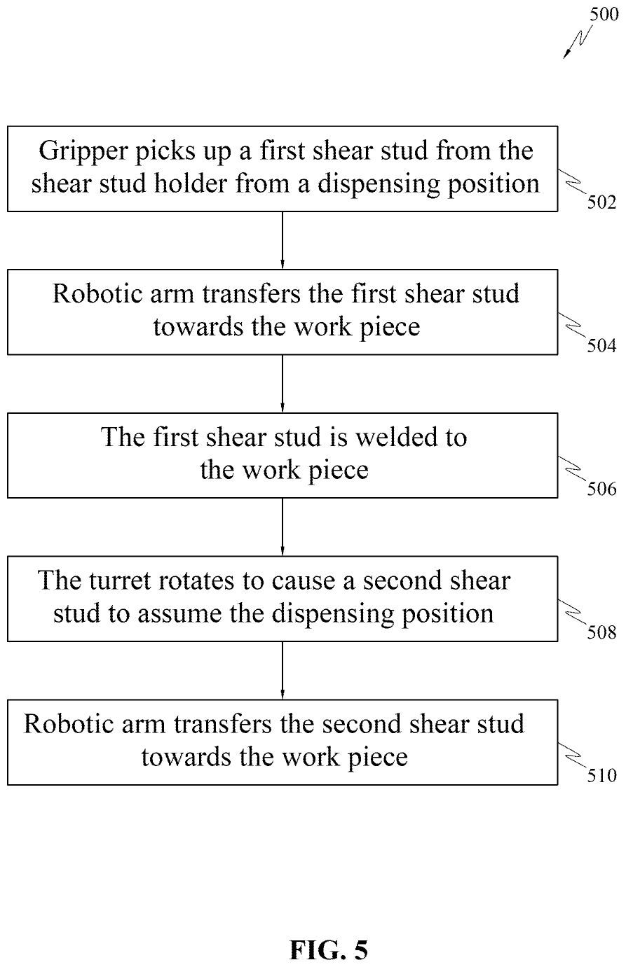

FIG. 5 is a flowchart of the shear stud welding process, in accordance with an embodiment. At step 502, the microcontroller 106 may cause the gripper 404 of the robotic arm 104 pick up the first shear stud from the shear stud holder 102 at a dispensing position.

At step 504, the microcontroller 106 may control the movement of the robotic arm 104 to transfer the picked up shear stud to the workpiece at a first welding position.

At step 506, the microcontroller 106 may control the welding of the first shear stud with the workpiece. The microcontroller 106 may control the plunging mechanism to control the welding.

At step 508, upon welding of the first shear stud, the microcontroller 106 may cause the first motor of the shear stud holder 102 to rotate the turret 302 to a predetermined angle. The rotation of the turret 302 causes a second shear stud to assume the dispensing position so that the gripper 404 may pick up the second shear stud.

At step 510, the microcontroller 106 may control the movement of the robotic arm 104 to pick up the second shear stud from the dispensing position.

The processes described above is described as a sequence of steps, this was done solely for the sake of illustration. Accordingly, it is contemplated that some steps may be added, some steps may be omitted, the order of the steps may be re-arranged, or some steps may be performed simultaneously.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A shear stud welding system, the system comprises:
a shear stud holder comprising:
a turret configured to:
hold a plurality of shear studs and a plurality of ferrules, wherein each of the ferrules is engaged with a shear stud among the plurality of shear studs; and
a first motor coupled to the turret, wherein the first motor is configured to rotate the turret about an axis to a predetermined angle such that a shear stud among the plurality of shear studs is at a dispensing position;
a robotic arm configured to transfer the shear stud from the shear stud holder to a workpiece, the robotic arm comprising:
a welding gun comprising a gripper configured to hold the shear stud along with the ferrule;
wherein the robotic arm causes the gripper to pick up the shear stud from the shear stud holder from the dispensing position; and
a microcontroller connected to the shear stud holder and the robotic arm, wherein the microcontroller is configured to:
control the movement of the robotic arm to pick up the shear stud from the dispensing position and transfer the shear stud holder to the workpiece at a welding position;
control the welding of the shear stud to the workpiece; and
cause the first motor to rotate the turret to the predetermined angle upon welding of the shear stud to the workpiece, wherein the rotation of the turret causes the shear stud among the plurality of shear studs assume the dispensing position.

2. The system of claim 1, wherein the turret defines a plurality of cavities, wherein each of the plurality of cavities is configured to receive at least a portion of one of the plurality of shear studs.

3. The system of claim 1, wherein the shear stud holder further comprises a stationary block that is rigidly fixed to a base, wherein the turret is coupled to the stationary block using a bearing.

4. The system of claim 1, wherein the turret comprises a plurality of support structures, wherein each of the plurality of support structures is configured to support one of the plurality of shear studs.

5. The system of claim 4, wherein each of the plurality of support structures comprises a pair of fasteners to tightly secure the shear stud to the support structure.

6. The system of claim 1, wherein the gripper is configured to:
constrict at the dispensing position to hold the shear stud and the ferrule securely; and
open at the welding position after welding the shear stud to the workpiece to release the shear stud.

7. The system of claim 6, wherein the gripper is an air actuated gripper.

8. The system of claim 7, wherein the system comprises a pneumatic mechanism to control the constriction and opening of the air actuated gripper.

9. The system of claim 8, wherein the microcontroller is configured to operate the pneumatic mechanism to control the constriction and opening of the air actuated gripper.

10. The system of claim 1, wherein the welding gun comprises a plunging mechanism coupled to the gripper, wherein the plunging mechanism enables the gripper along with the shear stud and the ferrule to traverse towards and away from the workpiece.

11. The system of claim 10, wherein the welding gun comprises a welding cable electrically connected to the shear stud via the gripper to maintain an electrical polarity at the shear stud.

12. The system of claim 11, wherein the workpiece is at an electrical polarity that is opposite to the electrical polarity of the shear stud.

13. The system of claim 12, wherein the microcontroller is configured to operate the plunging mechanism to control the movement of the gripper along with the shear stud and the ferrule, thereby maintaining a gap between the workpiece and the shear stud to generate an electrical arc between the shear stud and the workpiece.

14. The system of claim 13, wherein the microcontroller is configured to operate the plunging mechanism to push the shear stud towards the workpiece upon generating the electrical arc, thereby welding the shear stud to the workpiece.

15. The system of claim 1, wherein each of the ferrules is configured to shield an arc during the welding.

16. The system of claim 1, wherein the ferrules are made using a ceramic material.

17. The system of claim 1, wherein the ferrules are configured to be chipped off after welding the shear stud to the workpiece.

18. The system of claim 1, wherein the plurality of shear studs are arranged in a circular arrangement.
